(19) United States
(12) Patent Application Publication
(10) Pub. No.: US 2004/0137886 A1
(43) Pub. Date: Jul. 15, 2004

(54) Method and system for delivering electronic coupons to wireless mobile terminals

(76) Inventors: Monte Ross, St. Louis, MO (US); Mark L. Peterson, Olivette, MO (US); Matthew H. Klapman, Northbrook, IL (US)

Correspondence Address: Michael K. Lindsey, 21075 N. 20th St., Barrington, IL, 60010, US

(21) Appl. No.: 10/718,922

(22) Filed: Nov. 21, 2003

Related U.S. Application Data
(60) Provisional application No. 60/428,250, filed on Nov. 22, 2002.

(51) Int. Cl. H04M 3/42

(52) U.S. Cl. 455/414.1; 455/432.3

(57) ABSTRACT

A system for distributing electronic coupons includes plural wireless mobile terminals, such as cellular phones or personal digital assistants (PDAs), a customer profile database, and a server capable of accessing the customer profile database and communicating with the wireless mobile terminals over a wireless network. The database stores customer profiles for each of the wireless mobile terminals. The profiles include customer data, such as customer preferences and the current location of each wireless terminal. The server selectively transfers one or more electronic coupons to at least one of the wireless mobile terminals based on a comparison between the customer profiles and seller filtering criteria. A seller interface permits sellers to enter the seller filtering criteria. The filtering criteria can include the physical location of the seller so that coupons are sent only to those wireless terminals at or near the seller's location.

This application claims priority to U.S. Provisional Application No. 60/428,250 filed on Nov. 22, 2002, which is hereby incorporated by reference as though set forth in full.

### FIELD OF THE INVENTION

The invention relates generally to systems for distributing electronic coupons and advertisements, and more specifically, to a system for selectively delivering electronic coupons and/or advertisements to wireless mobile terminals, such as cellular phones and personal digital assistants (PDAs).

### BACKGROUND OF THE INVENTION

Wireless communication devices are becoming more affordable and more ubiquitous. Many wireless devices and networks include the ability to determine the geographical location of the user's device and therefore the location of the person with the device. When this data is also made available on a network, new opportunities exist for point-cast and multi-cast data delivery based upon that location, including advertisements and electronic coupons.

Systems are known for distributing electronic coupons and advertisements over networks to potential customers. However, these known systems do not generally address the problems associated with distributing coupons or ads over wireless networks. One problem in a wireless environment is that there is a higher cost to sending data over a wireless network, such as a cellular network, which typically has a smaller bandwidth than a wired network (e.g., the Internet or a private intranet). Thus, in wireless environments, selectively limiting the amount of advertising and promotional data sent to end-users is advantageous to advertising businesses because it can lower transmission costs.

Moreover, in both wired and wireless networks, there are many cases where advertisements and electronic coupons need to be sent to specific, targeted customers. For example, it would be a waste of bandwidth and nuisance for the recipient if an electronic coupon for a steakhouse in St. Louis, Miss. was sent to a wireless user in Alaska (especially if the coupon was only valid for the next two hours). It would also be a nuisance for a vegetarian to receive the same coupon. If the users of the network are to be receptive to advertising and coupons, then the amount and quality of those advertisements and coupons should be of high value to the potential customers.

In addition, a business advertising on a network may want to only disseminate electronic coupons to a limited set of customers, and possibly time limit those coupons with expiration dates and/or times in order to limit the reduced margins on sales generated by people using those coupons.

Accordingly, there is a need for a networked system of distributing electronic coupons and/or ads to wireless users that addresses the foregoing problems and needs.

### SUMMARY

It is an advantage of the present invention to provide an improved system and method to distribute advertisements and coupons in electronic form over a network to people through their wireless devices. According to one aspect of the invention, one or more filtering mechanisms are used to allow selective, targeted data delivery to reduce network traffic and increase the value of the advertisement and coupon data to the end user.

In accordance with an embodiment of the invention, a system for distributing electronic coupons includes a plurality of wireless mobile terminals, a customer profile database for storing customer profiles corresponding to the wireless mobile terminals, and a server, operatively coupled to the customer profile database and communicating with the wireless mobile terminals over a network. The server selectively transfers one or more electronic coupons to at least one of the wireless mobile terminals based on a comparison between the customer profiles and seller filtering criteria.

In accordance with another embodiment of the invention, an electronic coupon/advertisement system utilizes a wireless network with attached database servers. The servers hold information about specific end-users (customers) that utilize the wireless network. A seller (e.g., business) wishing to advertise or send an electronic coupon queries the server to determine which end-users should be sent the data or messages. The seller could use its own potential customer list and use the server as a filter to target a subset of their list, or the seller could allow the server to generate a user list based upon a set of filtering criteria. Multiple servers may be utilized, each with a different filtering function.

In accordance with a further embodiment of the invention, a wireless mobile terminal includes a display, a memory, a network interface for communicating with a server over a packet network, and a processor electrically connected to the display, the memory and the network interface. An application client program is stored in the memory and executable on the processor. The application program transfers the current location of the wireless mobile terminal to the server and also receives, stores and displays electronic coupons on the display. The electronic coupons are sent by the server, based on the current location of the wireless mobile terminal and/or other information stored in the customer profile corresponding to the mobile terminal.

Method counterparts to these embodiments are also provided. Other embodiments, systems, methods, features and advantages of the invention will be or will become apparent to one with skill in the art upon examination of the following figures and detailed description. It is intended that all such additional embodiments, systems, methods, features and advantages be included within the scope of the invention, and be protected by the accompanying claims.

### BRIEF DESCRIPTION OF THE DRAWINGS

The components in the figures are not necessarily to scale, emphasis instead being placed upon illustrating the principles of the invention.

FIG. 1 is a schematic diagram of an exemplary wireless communication system for distributing electronic coupons and advertisements in accordance with an embodiment of the invention.

FIG. 2 is a flowchart illustrating a method operating the system of FIG. 1 in accordance with a further embodiment of the invention.

FIG. 3 is a schematic illustration of a wireless mobile terminal of the system of FIG. 1.

FIG. 4 is a detailed block diagram showing the components included in the wireless mobile terminal of FIG. 1.

FIG. 5 is a detailed block diagram showing the components included in the electronic coupon server complex of FIG. 1

### DETAILED DESCRIPTION

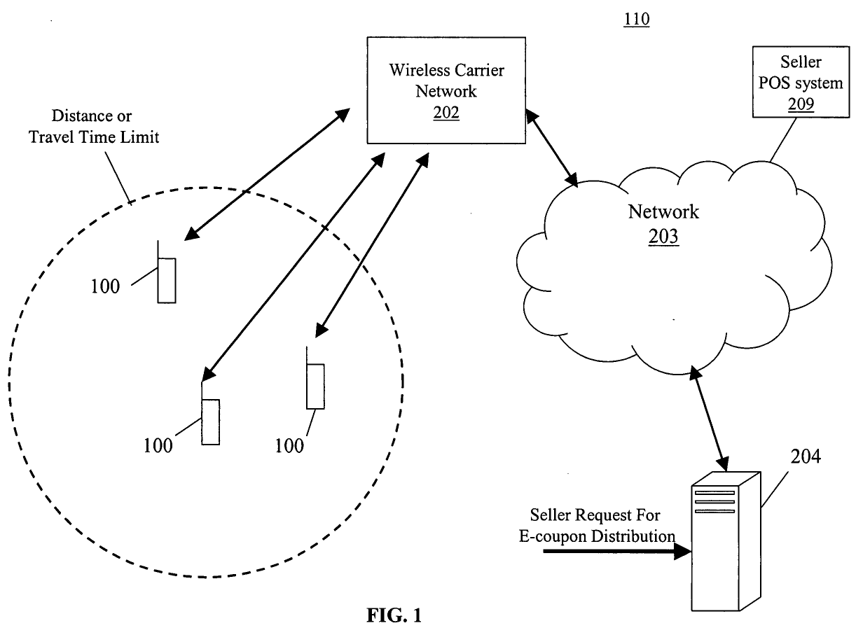

Turning now to the drawings, and in particular to FIG. 1, there is illustrated an exemplary wireless electronic coupon system 110 comprising a plurality of mobile terminals 100 in accordance with an embodiment of the present invention. The terminals 100 communicate with an electronic coupon server complex 204 by wirelessly transmitting data to a corresponding wireless carrier's infrastructure 202. As known in the art, the wireless carrier infrastructures 202 comprise those elements necessary to support wireless communications with the terminals 100. Various service providers (such as Verizon, Cingular or Sprint in the U.S.) build and maintain such infrastructures.

The wireless operator may deploy different wireless data technology in the wireless carrier network 202, such as Global System for Mobile Communication's (GSM) General Packet Radio Service (GPRS) and Code-Division Multiple Access's (CDMA) Single Carrier Radio Transmission Technology (1xRTT). In this respect, the electronic coupon system disclosed herein does not depend on the data wireless technology employed.

From the wireless carrier network 202, data packets are sent on to a packet communication network 203, such as the Internet, that forwards them onto the server complex 204.

The communication network 203, which is a packet-based network, may comprise a public network such as the Internet or World Wide Web, a private network such as a corporate intranet, or some combination of public and private network elements. The server complex 204 preferably comprises a plurality of networked server computers that may be programmed to implement the functionality described below. The particular number of servers used and the manner in which they communicate with each other is a matter of design choice. Techniques for programming server computers and mobile terminals are well known in the art.

When the server complex 204 communicates with one or more mobile terminals, the server complex 204 sends its data to the network 203 that, in turn, forwards the data onto the carrier infrastructure 202. The carrier infrastructure 202 then transmits the data to one or more of its corresponding mobile terminals 100.

The server complex 204 can be placed inside a wireless carrier's infrastructure 202. Furthermore, the present invention would benefit systems other than packet based systems, as well as systems that are limited in scope to a single wireless carrier's domain.

When the server complex 204 resides outside a carrier's domain, it is able to service mobile terminals 100 that are associated with different wireless carriers. In effect, the system disclosed herein is independent of the wireless operators. They do not require any special hardware or software to be placed within the operator wireless network 202. The wireless operator's network 204 (in conjunction with the public network 203) acts as a communication pipe between the mobile terminal 100 and the server complex 204. Preferably, standard packet data transfer protocols are used to transmit and route data messages back and forth between the mobile terminal 100 and the server complex 204, such as the Internet Protocol (IP), Transmission Control Protocol (TCP), User Datagram Protocol (UDP), and World Wide Web protocols, such as the Hypertext Transfer Protocol (HTTP). The server complex 204 acts as a gateway between the various transfer protocols.

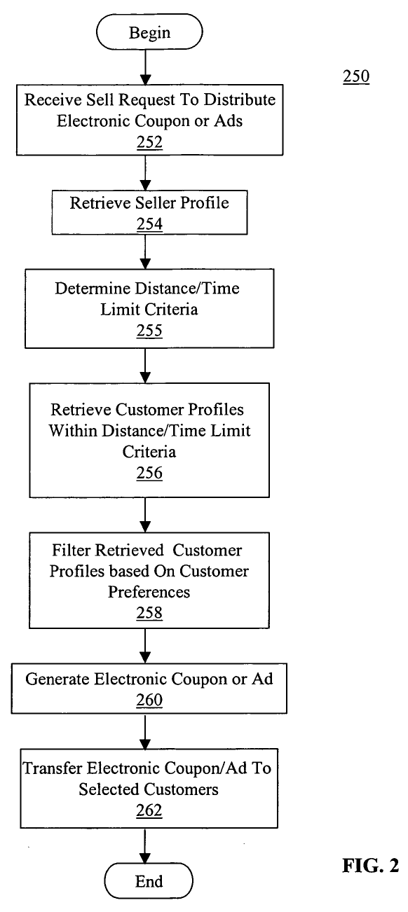

FIG. 2 is a flowchart illustrating a method 250 of operating the system 110 of FIG. 1 in accordance with a further embodiment of the invention. In step 252, a seller request to distribute e-coupons or advertisements is received at the server complex 204. The seller request identifies the good or service to be offered, a coupon offer (if available) designating the discount offered and any other terms of the offer, such as limits on quantity, expiration dates and/or times, participating locations, and the like. The seller request can also specify other particular seller defined filtering criteria, such as the number of offers to be made, type of goods, product or service, a maximum distance, a latest arrival time, prior customers, landmark information (e.g., freeway exits or entrances), or any other suitable parameter for selecting targeted customers to distribute the coupon or ad.

The seller request can be transferred to the server complex using any suitable technique, such as email, fax, phone call, web browser interface, or the like.

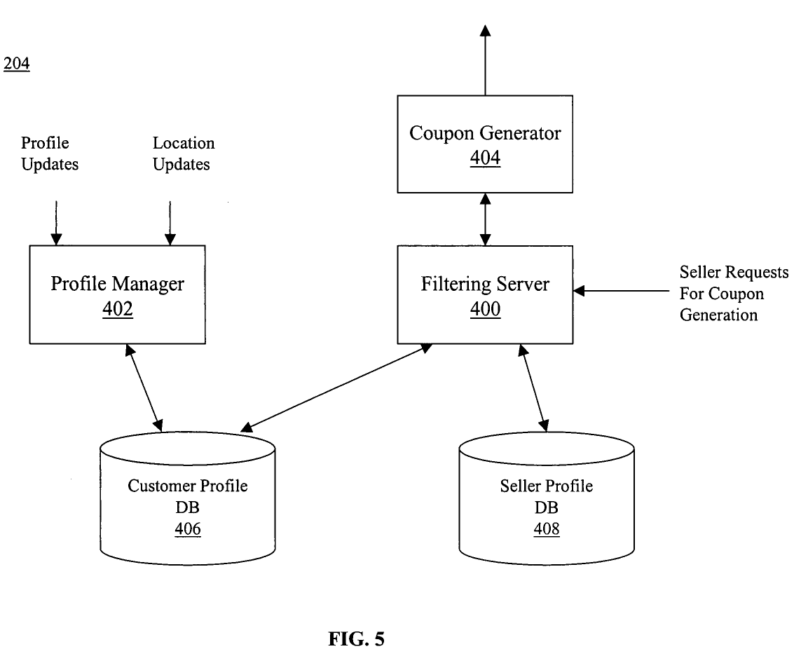

In step 254, a seller profile corresponding to the seller's request is retrieved from a seller profile database (DB) 408(see FIG. 5). The profile includes, among other things, the seller's location (e.g., GPS coordinates and street address) and contact information, such as phone number, email, and other information pertaining to the seller, such as usage history, existing customer lists, dining menus, authentication information and the like. The seller can establish a profile by subscribing to the electronic coupon (e-coupon) service offered by the operator of the server complex 204.

The seller profile can be populated with seller information using a conventional web browser and web server configured to access and store data in the DB 408.

In step 255, a distance and/or time limit criteria is determined for the seller request. These criterion are set by the seller request. The distance criteria sets the maximum distance from the seller location at which the coupon or ad will be sent to a wireless mobile terminal 100.

The time limit criteria sets the time at which the coupon offer will expire. The time limit is used to indirectly determine the maximum distance at which a wireless terminal will receive the coupon, based on wireless terminal's current location and the expected travel time to the seller location. The expected travel time can be estimated from traffic statistics or derived from traffic congestion reporting services, which are publicly available over the Internet. A web-based application can be included in the server complex 204 for retrieving traffic information and computing expected travel and arrival times for each of the wireless terminals 100.

Using the time limit scheme, the application determines the travel times between the current locations of the wireless mobile terminals and the seller's physical location based on the traffic information. Using the estimated travel times and current time of day, the application then determines estimated arrival times for the wireless terminal based on the travel times. Using this calculation, electronic coupons are sent only to those wireless mobile terminals having an estimated arrival time prior to the latest arrival time set by the seller request.

In step 256, a customer profile database 406 (see FIG. 5) is searched based on the current locations of wireless terminals 100 to retrieve a list of potential customers currently within the distance/time limit criteria established by the seller request. An application for computing the distance between current location of each wireless mobile terminal 100 and the physical location of the seller is included on the filtering server 400 in the server complex 204. The distance computing application can be a commercially-available street mapping/routing program, or a routing service available over the Internet or World Wide Web (WWW). Based on this computation, and/or the estimated arrival time computation discussed above, the application selects those wireless mobile terminals 100 within the maximum distance or able to arrive prior to the latest arrival time.

In step 258, the list of potential customers is further refined by filtering the list based on information contained in the corresponding customer profiles. To accomplish this, a comparison is made between information other than current terminal location contained in the listed customer profiles and information contained in the seller profile and/or request. This other information includes, but is not limited to: membership (is the customer on a list of the business vendor or other group), personal preference data such as diet preferences (e.g. vegetarian, kosher meals, food allergies), other allergies, hobbies, home address, and demographic data such as age, gender, marital status, net worth, pet owner, political party affiliation, and the like.

In step 260, an electronic coupon and/or ad is generated in one or more formats suitable for display on the terminals of the selected customers. If the customers are using different types of terminals or terminal display applications that require different data formats for displaying the coupon or ad, then the system can generate the coupon in the different formats. The particular format required by a customer can be indicated by the static data storing the customer's profile.

Alternatively, the data can be sent in a generic database format, such as XML, that the device can use to render appropriately to the display of that particular device.

In addition, the coupon generator 404 (see FIG. 5) in the server complex 204 can include a database of electronic coupon templates that include graphics and text arranged to represent the coupon. A seller request can select one of these templates and the coupon generator 404 includes an application for automatically populating the template with the appropriate coupon information of the seller request to create the electronic coupon that is then distributed to the wireless terminals 100.

The coupon generator 404 can include an application for generating a barcode that is included in the electronic coupon and displayable on the screen 102 of the mobile terminal 100. When the customer presents the coupon on the screen 102 to the seller, the seller can scan the barcode using a seller point-of-sell (POS) system 209 to enter the coupon discount and information into the seller's inventory or POS system 209.

In step 262, the electronic coupon server complex 204 transfers the electronic coupon and/or ad to the selected customer mobile terminals 100 over the networks 203, 202. The coupon/ad can be transferred as a packetized message to a client application residing on the wireless terminals 100. The client application then stores and/or displays the coupon/ad to the user of the wireless terminal. The client application can acknowledge the receipt of the coupon/ad to the server complex 204.

After receiving the coupon, the user of the mobile terminal 100 can proceed to the seller location and redeem the coupon. As discussed above, the user can display the coupon the seller and the seller's POS system 209 for barcode scanning. Alternatively, the user can download the coupon data from the mobile terminal 100 to the seller POS system 209 using a transceiver 317 included in the mobile terminal 100, as discussed below.

The seller POS system 209 can be a networked system that is configured to communicate with the server complex 204 over the network 203. After redemption of the coupon, the seller POS system 209 sends an indication of the redemption and coupon data to the server complex 204. The server complex 204 can update seller information stored in the seller profile DB 408 based on the redemption, such as the total number of responses to the coupon offer and the number of remaining valid coupon offers.

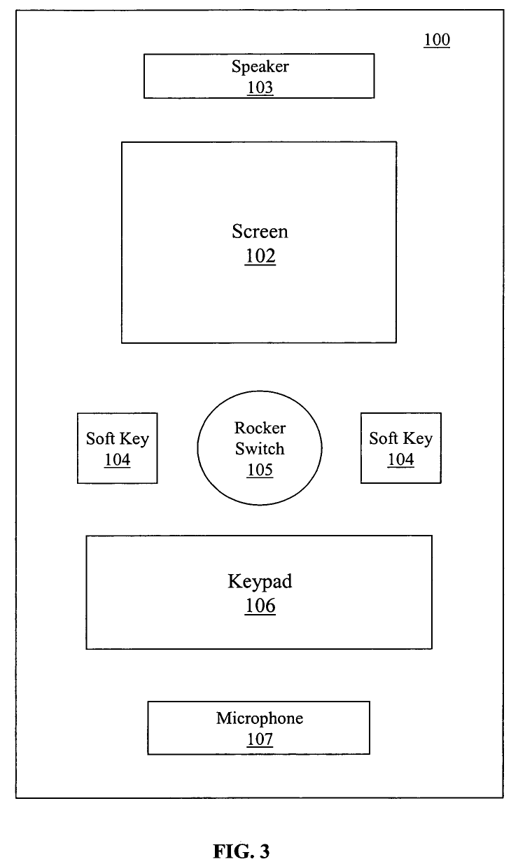

FIG. 3 illustrates details of an exemplary wireless mobile terminal 100 usable in the system 110 of FIG. 1. The terminal 100 can be any suitable wireless communication device, such as a handheld cellular phone or a wirelessly enabled Personal Digital Assistant (PDA).

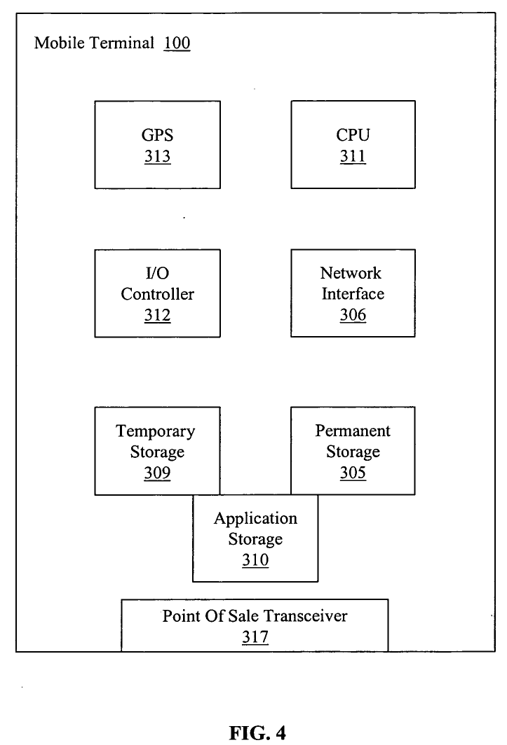

The configuration of the mobile terminal 100 shown in FIG. 3 is exemplary only, and it is generally understood that a variety of terminals and terminal configurations could be used. As shown, the mobile terminal 100 comprises a speaker 103 for rendering audio, such as received speech; a display 102 to render text and graphical elements visible; a navigation rocker 105 that allows a user to navigate a list or menu displayed on the screen; programmable buttons (or “softkeys”) 104; a keypad 106 that allows the user to input digits, letters, and other symbols (e.g., punctuation); a microphone 107 that captures audio such as the user's speech. These and other components of the mobile terminal (not shown) are well known in the art. Additionally, there are a variety of styles and instances of components that can be used instead of (or in conjunction with) the components described in FIG. 3. For example, touch screens and hand writing recognition techniques can replace the need for the softkeys 104, the navigation rocker 105, and the keypad 106. The present invention is not limited in this regard. Additional components of the terminal that are not necessarily visible to the user but are useful to implement electronic coupon functionality are further described with reference to FIG. 4.

FIG. 4 illustrates in more detail components found in each of the terminals 100. Focusing on the components of the terminal 100, machine-readable and executable instructions (typically referred to as software, application, code, or program) are preferably stored in an application storage (or memory) 310 and executed (or run) on a central processing unit (CPU) 311. All storage devices described herein may comprise any combination of volatile (e.g., random access memory) or non-volatile (e.g., read-only memory) storage as known in the art. Likewise, the CPU 311 may comprise a microprocessor, microcontroller, digital signal processor, co-processor, similar devices or combinations thereof. Using known programming techniques, the software stored in the memory 310 can manipulate the display screen 102, capture speech from the microphone 107, transmit and receive data over a point-of-sale (POS) transceiver 317, capture input data from the key pad 106, navigation rocker 105, soft keys 104 using the I/O controller 312.

The POS transceiver 317 is a transceiver for transmitting electronic coupon data from the mobile terminal 100 to a point of sale system at the seller location to effect redemption of the coupon. The transceiver 317 is optionally included in the mobile terminal 100, and can be any suitable communication port capable of interfacing to a merchant POS system, such as an electrical contact port, e.g., a USB port, RS232 port or the like, or a wireless port, e.g., a Wi-Fi port, Bluetooth port, or IrDA port. Such transceivers are commercially-available and can be readily interfaced to the CPU 311.

The terminal 100 also includes a global position system (GPS) subsystem 313 for providing the real-time physical location of the terminal. The GPS subsystem 313 can be a commercially-available component having a standard bus interface with the CPU 311 and/or the I/O controller 312. Alternatively, the wireless carrier network 202 can determine the location of the terminal 100 through known base station radio frequency (RF) triangulation techniques, such as being used in the upcoming E911 system, and send the location information to the terminal 100 or the server complex 204 for further processing.

Outbound messages sent to the server complex 204, as well as those inbound messages received from the server complex 204, pass through the network interface 306 that provides connectivity between the terminal and the data network 203. The network interface 306 comprises the entire physical interface necessary to communicate with the server complex 204, including a wireless transceiver.

The software uses temporary storage 309 to save working data that does not persist between communication sessions. On the other hand, the software uses the permanent storage 305 to persist data for longer periods of time that can span multiple communication sessions. Such data can include static profile data as described herein.

The mobile terminal 100 can be a commercially-available 3G cellular phone running a standard operating system, such as Symbian, and a client application (not shown) for running on the CPU 311 of the phone to support the electronic coupon system described herein.

The client application can be executed automatically on power up of the mobile terminal unit or it can be executed by user command, such as a soft key 105 selection of an icon appearing on the display 102. The client application transfers the current location of the wireless mobile terminal 100 to the customer profile DB 406 in the server complex 204. The current location can be that indicated by the GPS subsystem 313. Alternatively, the current location can be a base station identifier available to the wireless terminal 100 when it connects to the base station, which is included in the carrier network 202. The server complex 204 can include a database of base station identifiers and their corresponding physical locations to roughly determine the current location of wireless terminal as being that of the base station.

The client application also receives and displays on the display 102 the electronic coupons and ads selectively sent by the server complex 204. The server complex can employ a conventional keep-alive scheme to maintain an IP connection to the client application.

The client application also transfers coupon redemption data to the seller POS system using the POS transceiver 317. A user can select the coupon using the keypad or softkeys, and can indicate that the relevant coupon data needed for redemption, such as discount value, seller ID, and the like, is to be downloaded from the mobile terminal 100 to the seller POS system.

The client application also stores the electronic coupon or ad in either the temporary or permanent memory 305, 309 for later retrieval and display by the end user.

The client application also includes an administrative interface for allowing a user to create a customer profile and for entering and updating profile information, such as static data, in his/her profile stored in the customer profile DB 406.

FIG. 5 is a detailed block diagram showing exemplary components included in the electronic coupon server complex 204 of FIG. 1. The server complex 204 includes a filtering server 400, a profile manager 402, a coupon generator 404, and customer profile database (DB) 406, and a seller profile database (DB) 408. The server complex 204 can include additional servers and arrangements of servers other than the one illustrated in FIG. 5.

The filtering server 400 can include one or more applications for filtering the data in the customer profile DB 406 to select a list of wireless customer terminals to forward the electronic coupons and ads. The filtering server 400 also includes a seller interface (not shown) for permitting sellers to input seller requests into the system, as discussed above in connection with FIG. 2.

The profile manager 402 includes one or more servers for creating, maintaining and updating the customer profiles stored in the customer profile DB 406. The profile manager 402 receives messages from either the administrative interface of the client application running on the wireless terminals 100 or the update current location function of the client application. The profile manager 402 is capable of maintaining an always-on connections with the mobile client applications.

The databases 406, 408 can be implemented using commercially-available database applications, such as Oracle.

Each of the customer profiles in the customer profile DB 406 can include “static data”, “dynamic data” or any combination thereof. Static data includes data that does not change frequently, such as customer name, customer ID, association memberships, diet preferences, age, gender, allergies, hobbies, home address, email address, and the like. Dynamic data includes information that is subject to frequent change, such as the current customer location, time-of-day, calendar date, time of arrival, and the like.

Preferably, the only dynamic data stored in the customer profile DB 406 for each wireless mobile terminal 100 is the current location. The other dynamic data, such as time of day, date, arrival time can be determined locally on the filtering server 400.

### I. Example Operational Scenario Illustrating The Advantage Of The Disclosed System

A restaurant owner located in Chicago, Illinois wants to sell her latest entree this evening because the fish she is using was flown in today from the east coast and will spoil by the next day. She decides that an electronic coupon discounting the meal by 20% is the fastest and most efficient way to alert her regular customers in the area. She emails her electronic coupon order to a third party who maintains the server complex 204 and her customer database (in the seller profile DB 408), as well as other potential customers in the system. The order says to send a coupon to the 1000 past customers who previously ordered fish, and only to those customers that are within 20 miles of the restaurant or those customers that could make it to the restaurant before the restaurant stops serving dinner, today at 9:30 pm. Also, the coupon is set to expire when the restaurant stops serving dinner.

The third party, using application software on the filter server 400, culls the database of previous customers, filters the list based upon the previous fish orders and sets the expiration of the coupon to 9:30 pm (as an announcement on the coupon, or electronically, where the end-user's mobile terminal, if a thick-client, erases the coupon at 9:30 pm).

Next, the third party queries the customer profile DB 406 that has the current location of the potential customers as obtained by each customer's respective wireless carrier and/or device's internal GPS sub-system 313. Then the best case routing conditions for someone to drive to the restaurant, taking into account the current traffic congestion (sensor accumulated or time-of-day trend), are calculated with a mapping database to filter out those who could not make it to the restaurant in time for dinner via car or public transportation. Then the customers that could not make it in time by car but are within the 20 mile radius to the restaurant are added to the list. Finally, the list is tagged to limit the amount of electronic coupons to the first 1000 customers who successfully receive the message on their wireless device. The message sending the electronic coupon to the wireless end user devices can include a request for an acknowledgement flag, which causes the application client on the wireless terminals to send an acknowledgement message back to the server complex 204 indicating a successful reception of the coupon.

The third party then sends the electronic coupons via the packet network 203 for delivery to the appropriate wireless cellular networks 202 for ultimate delivery to the end-users' wireless terminals 100.

At 6:00 pm, the restaurateur begins seeing customers who are using the electronic coupon by either showing the screen of their phone with the coupon to the restaurateur, allowing the restaurateur to barcode scan directly off of the screen of the phone, or by wirelessly transmitting the coupon to the restaurant's system to log the discount. The restaurateur decides, based upon the current turnout at 7:00 pm to send out 500 more coupons with better customer terms, such as a 50% discount, in order to sell out all of the fish. She forwards an email to the third-party server complex 204, and the process discussed above is repeated for the new request. If the end users respond to the coupon offer, by 9:30 pm the restaurateur is secure in knowing the electronic coupons are expired and that she has little fish left to waste.

While various embodiments of the invention have been described, it will be apparent to those of ordinary skill in the art that many more embodiments and implementations are possible that are within the scope of this invention. For example, any combination of any of the systems or methods described in this disclosure are possible.

What is claimed is:

1. A system for distributing electronic coupons, comprising:
a plurality of wireless mobile terminals;
a customer profile database for storing a plurality of customer profiles corresponding to the wireless mobile terminals; and
a server, operatively coupled to the customer profile database and communicating with the wireless mobile terminals over a network, for selectively transferring one or more electronic coupons to at least one of the wireless mobile terminals based on a comparison between the customer profiles and seller filtering criteria.

2. The system of claim 1, further comprising:
means for determining the current location of each of the wireless mobile terminals and storing data representing the current location in the customer profile database.

3. The system of claim 2, wherein the determining means includes a global positioning system (GPS) subsystem in each of the mobile wireless terminals and an application in each of the mobile wireless terminals for transferring the location indicated by the GPS subsystem to the customer profile database.

4. The system of claim 2, wherein the determining means includes an application for determining the current location based on a base station identifier associated with each of the wireless mobile terminals.

5. The system of claim 2, wherein the determining means includes an application for determining the current location based on a base station RF triangulation method performed by wireless network infrastructure.

6. The system of claim 1, wherein the seller filtering criteria includes a maximum distance between the physical location of the seller and a potential customer.

7. The system of claim 6, further comprising an application for computing the distance between the current location of each of the wireless mobile terminals and the physical location of the seller and for selecting those wireless mobile terminals within the maximum distance.

8. The system of claim 1, wherein the seller filtering criteria includes a latest arrival time.

9. The system of claim 8, further comprising:
means for determining the travel times between the current locations of the wireless mobile terminals and the seller's physical location; and
means for determining estimated arrival times for the wireless terminal based the travel times; and
means for transferring the electronic coupons only to those wireless mobile terminals having an estimated arrival time prior to the latest arrival time.

10. The system of claim 9, wherein the means for determining driving times includes a publicly available traffic congestion server.

11. The system of claim 1, further comprising:
a seller interface, operatively coupled to the server, for permitting sellers to enter the seller filtering criteria.

12. The system of claim 1, wherein the seller filtering criteria includes parameters selected from the group consisting of service type, goods type, latest arrival time, coupon expiration date, coupon expiration time, discount amount, coupon offer, seller physical location, landmark information, and any combination of the foregoing.

13. The system of claim 1, wherein each of the customer profiles includes data selected from the group consisting of static data, dynamic data and any combination of the foregoing.

14. The system of claim 13, wherein the static data includes data selected from the group consisting of name, customer ID, association membership, diet preferences, age, gender, allergies, hobbies, home address, email address, and any combination of the foregoing.

15. The system of claim 13, wherein the dynamic data includes current location, time-of-day, calendar date, time of arrival, and any combination of the foregoing.

16. The system of claim 1, wherein each of the wireless terminals includes a display for presenting the electronic coupons to a seller from redemption.

17. The system of claim 16, wherein the electronic coupon displays a barcode capable of being scanned by the seller.

18. A method for distributing electronic coupons to wireless mobile terminals, comprising:
storing a plurality of customer profiles corresponding to a plurality of wireless mobile terminals;
selecting at least one of the wireless mobile terminals based on a comparison between the customer profiles and seller filtering criteria; and
transferring over a wireless network one or more electronic coupons to the at least one wireless mobile terminal.

19. The method of claim 18, further comprising:
determining the current location of each of the wireless mobile terminals; and
storing data representing the current location in the customer profile database.

20. The method of claim 19, wherein the step of determining includes:
determining the current location using a global positioning system (GPS) subsystem in each of the mobile wireless terminals; and
transferring the current location indicated by the GPS subsystem to the customer profile database.

21. The method of claim 19, wherein the step of determining includes:
determining the current location based on a base station identifier associated with each of the wireless mobile terminals.

22. The method of claim 19, wherein the step of determining includes:
determining the current location based on a base station RF triangulation method performed by wireless network infrastructure.

23. The method of claim 18, wherein the seller filtering criteria includes a maximum distance between the physical location of the seller and a potential customer.

24. The method of claim 22, further comprising:
computing the distance between the current location of each of the wireless mobile terminals and the physical location of the seller; and
selecting those wireless mobile terminals located within the maximum distance.

25. The method of claim 18, wherein the seller filtering criteria includes a latest arrival time.

26. The method of claim 25, further comprising:
determining the travel times between the current locations of the wireless mobile terminals and the seller's physical location; and
determining estimated arrival times for the wireless terminal based on the travel times; and
transferring the electronic coupons only to those wireless mobile terminals having an estimated arrival time prior to the latest arrival time.

27. The method of claim 26, further comprises:
using a publicly available traffic congestion server for determining driving times.

28. The method of claim 18, further comprising:
receiving the seller filtering criteria from at least one seller.

29. The method of claim 18, wherein the seller filtering criteria includes parameters selected from the group consisting of service type, goods type, latest arrival time, coupon expiration date, coupon expiration time, discount amount, coupon offer, seller physical location, landmark information, and any combination of the foregoing.

30. The method of claim 18, wherein each of the customer profiles includes data selected from the group consisting of static data, dynamic data and any combination of the foregoing.

31. The method of claim 30, wherein the static data includes data selected from the group consisting of name, customer ID, association membership, diet preferences, age, gender, allergies, hobbies, home address, email address, and any combination of the foregoing.

32. The method of claim 30, wherein the dynamic data includes current location, time-of-day, calendar date, time of arrival, and any combination of the foregoing.

33. A wireless mobile terminal, comprising:
a display;
a memory;
a network interface for communicating with a server over a packet network;
a processor, operatively coupled to the display, the memory and the network interface; and
an application stored in the memory and executable on the processor, for transferring the current location of the wireless mobile terminal to the server and for receiving and displaying on the display an electronic coupon selectively sent by the server based on the current location of the wireless mobile terminal.

34. The wireless mobile terminal of claim 33, further comprising:
a global positioning system (GPS) subsystem for indicating the current location of the wireless mobile terminal.

35. The wireless mobile terminal of claim 33, wherein the application stores the electronic coupon in the memory.

36. The wireless mobile terminal of claim 33, wherein the application includes means for allowing a user to enter information into a customer profile stored in a database accessible by way of the packet network.
